(19) United States
(12) Patent Application Publication
(10) Pub. No.: US 2014/0324239 A1
(43) Pub. Date: Oct. 30, 2014

(54) SYSTEM AND METHOD TO ADAPTIVELY REGULATE AN ENERGY CONSUMPTION OF A DEVICE

(71) Applicant: GENERAL ELECTRIC COMPANY, Schenectady, NY (US)

(72) Inventors: Hubert Zettel, Waukesha, WI (US); Paul Holdredge, Whitefish Bay, WI (US)

(73) Assignee: General Electric Company, Schenectady, NY (US)

(21) Appl. No.: 13/872,330

(22) Filed: Apr. 29, 2013

(51) Int. Cl. G05B 13/02

(52) U.S. Cl. CPC G05B 13/026
USPC 700/291

(57) ABSTRACT

A system and method to regulate an energy consumption of a medical device having a plurality of subsystems is provided. The system includes a controller connected in communication with the medical device. The controller has a series of program instructions for execution by a processor to perform the steps of calculating a predicted variability in a customer load on the medical device over a future time period. The controller can generate a signal with an instruction of a demand for one of a plurality of operating states of the medical device based on the predicted customer load, and communicate the signal to the device so as to change the operating state of the medical device.

### TECHNICAL FIELD

The subject herein generally relates to a system and method to adaptively regulate an energy consumption of a device, and more specifically, to establish a predictive demand of the device and a provide control signals to vary an operation state of the device based on the predictive demand.

### BACKGROUND

There are many devices in operation that involve variable rates of high electrical demand and associated variability in heat dissipation. Such devices can vary in size and shape, and may include batteries as power sources, and can be found throughout various industries or commerce. Such variable demand devices may also require special protocol in either timing to boot up and startup to an ON operating state, or in timing to a shut-down to an OFF operating state, and variable operating states (e.g., IDLE or STANDBY) therebetween.

Operators of such devices are faced with the challenge controlling the energy consumption and/or costs associated with operating such devices. U.S. Patent Publication No. 20050206769, entitled “DIGITAL RADIOGRAPHY DETECTOR WITH THERMAL POWER MANAGEMENT”, to Kump et al. teaches a system and method of triggering changes in operating states of image acquisition devices to a sleep mode in response to failure to detect an activation trigger within a predetermined time period, thereby reducing the energy demand of the image acquisition device and a cooling apparatus associated with operation of the device. This reference does not address the need provided for by the subject matter described herein.

The above-mentioned challenge can be addressed by the subject matter described herein in the following description.

### BRIEF SUMMARY

The system and method of the subject matter described herein is directed to provide a system or method to adaptively regulate an energy consumption of a device.

According to one embodiment, a system to regulate an energy consumption of a device having a plurality of subsystems is provided. The system includes a controller connected in communication with the medical device. The controller includes a plurality of program instructions for execution by a processor to perform the steps of: calculating a predicted variability in a customer load on the medical device over a future time period, and generating a signal with an instruction of a demand for one of a plurality of operating states of the medical device based on the predicted customer load, and communicating the signal to the device. The signal is provided change the operating state of the device.

According to another embodiment, a method to regulate an energy consumption of a device having a plurality of subsystems is provided. The method includes the steps of calculating a predicated variability in a customer load over a future time period on the medical device using a processor; generating a signal with an instruction to demand one of a plurality of operating states of the medical device based on the calculating step; and communicating the signal over a network to the device, wherein the signal changes the operating state of the medical device.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of an embodiment of a system to adaptively regulate an energy consumption of a device in accordance with the subject matter described herein.

FIG. 2 is a schematic flow diagram of an embodiment of a method of operating the system of FIG. 1 in accordance with subject matter described herein.

FIG. 3 is a schematic diagram of an embodiment of an output generated by the system of FIG. 1 in executing the method of FIG. 2 in accordance with the subject matter described herein.

### DETAILED DESCRIPTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

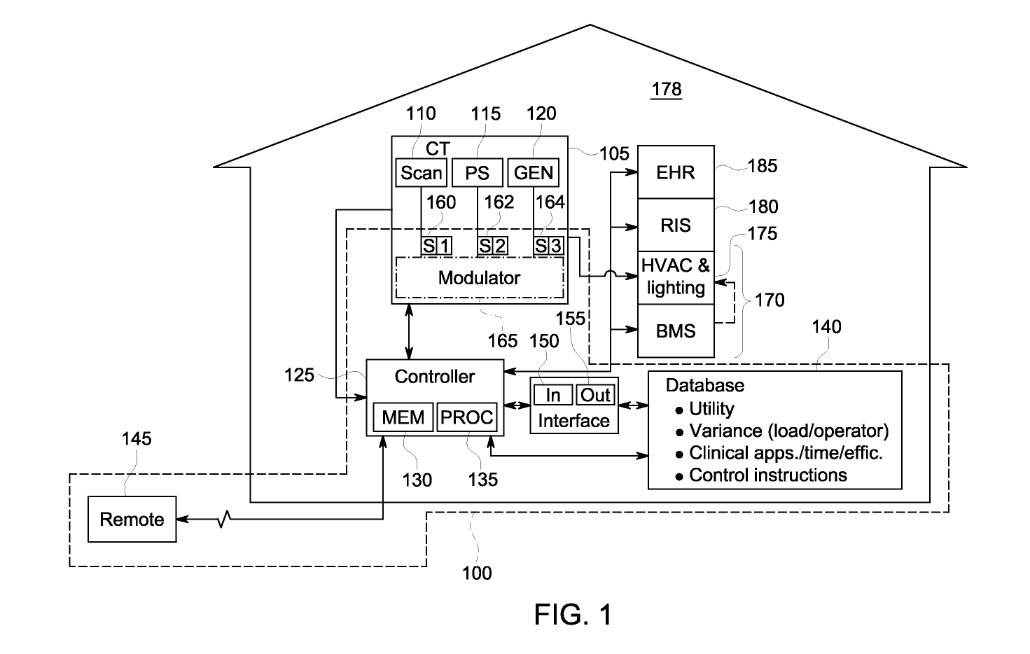

FIG. 1 illustrates one embodiment of a system 100 to adaptively regulate an energy consumption of a device 105. Examples of energy consumption can include demand for electrical power, electrical current, etc.

A preferred embodiment of the device 105 can be a medical device having controls for variable energy demand, such as those configured to perform various types of diagnostic imaging (e.g., x-ray, interventional, fluoroscopy, mammography, computed tomography, magnetic resonance, ultrasound, radiography, Positron Emission Testing (PET), etc.) acquisition, or a picture archival system (PACS). Yet, the type of device to have its energy consumption regulated or adapted can vary. The system 100 of the subject matter described herein may be employed to regulate energy consumption of multiple devices 105, or an isolated device 105, where a view into management of variable energy consumption and cost over time is desired by the user or operator of the device(s) 105.

One embodiment of the device 105 can include a series of subsystems 110, 115, 120 associated with all or a substantial portion of modulating the energy or power consumption of the overall device 105. Each of the subsystems 110, 115, 120 can include one or more controls to vary operation, and associated with modulating or varying the energy or power consumption, respectively, either individually or collectively. For example, FIG. 1 illustrates a CT type medical device 105 for sake of illustration, which can include one or more subsystems 110, 115, 120 operable to modulate the power consumption associated with operation of the CT type medical device 105. Examples of the subsystems 110, 115, 120 can include one or more of the following: generator, image scanner/detector, power supply, operator controls, cooling system, system electronics, etc. Each of the subsystems 110, 115, 120 can be capable of multiple operation states that result in multiple varied rates of energy consumption of the overall CT imaging device 105. For example, one or more of the subsystems 110, 115, 120 can have an ON state that results in energy consumption and an OFF state that results in minimal or generally zero rate of energy consumption. In another example, one or more subsystems 110, 115, 120 can include an ON state and an OFF state as described above, and further include a STANDBY or IDLE state that results in a rate of consumptions that is less than the ON state but at least more than the OFF state. Each of the varied rates of energy consumption associated with each of the operation states can be associated with varied duty cycles of the subsystem 110, 115, 120 or device 105. Of course, the list of subsystems 110, 115, 120 is shown for sake of example and is not limiting on the subject matter described herein.

The embodiment of the system 100 can include a controller 125 connected in communication with the device 105. The controller 125 can include a memory 130 having one or more non-transitory storage mediums with programming instructions for execution by at least one processor 135. Examples of the memory 130 can include integrated or portable storage, such as a hard drive, disk storage, tape drive, random access memory (RAM), read-only memory (ROM), flash memory, compact disk (CD), digital versatile disks (DVDs), magnetic cassettes, magnetic tape, magnetic disk storage, or any other medium operable to be used to store computer readable instructions. Although the memory 130 and processor 135 are shown at the controller 125, it should be understood that the memory 130 or processor 135 can comprise remote portions.

The controller 125 can also include and be in communication with a database 140 to receive and store digitized data, configuration parameters, data log files, device operation instructions, and so forth for later retrieval by the controller 125. The controller 125 may also include communication circuitry (wired or wireless) for providing interactive data exchange with a remote computer station 145.

The controller 125 can also include and be in communication (either wired or wireless) with an input device 150 and an output device 155. Examples of the input device 150 include one or a combination of a keyboard, an touch screen or graphic interface, mouse, toggle switches, joystick, tracker ball, or the like operable to receive data from an operator of the system 100. Examples of the output device 155 can include monitors, touch-screens or graphic interfaces, kiosks, dashboards, an alarm, light emitting diodes (LEDs), printer, audible speaker, pager, cellular phone, personal data assistant (PDA), etc. operable to visually or audibly show an output from the controller 125 for illustration to a user of the system 100. The input and output devices 150 and 155 can be combined as an operator interface in communication with the controller 125.

The system 100 may also include one or more sensors 160, 162, 164 in communication with the controller 125. Examples of the sensors 160, 162, 164 can be configured to detect specific operating parameters of the subsystems 110, 115, 120 or the device 105, such as (but not limited to) temperature, current, voltage, and vibration, values of which may also be analyzed and stored at the controller 125 as described below to provide an indicative value or weighted parameter associated with an available performance of the device 105.

The system 100 can further include a system modulator 165 in communication between the controller 125 and the device 105. The system modulator 165 can be configured to dynamically control operation of one or more of the subsystems 110, 115, 120 of the device 105 in response to receiving the signal from the controller 125 in a manner to adaptively regulate the power consumption of the device 105.

An embodiment of the controller can be generally configured to be in communication to provide wired or wireless signals that include instructions configured to regulate the power or control the mode or state of operation of the various subsystems 110, 115, 120 or the device 105, as described above. This aspect of the controller can be operable in combination with operation of the system modulator 165, or individually thereof. In addition, controller 125 can acquire feedback and analyze various operating parameters of the subsystems 110, 115, 120 or the device 105.

This acquisition of feedback can be associated with the various power or control signals applied to the subsystems 110, 115, 120 or device 105 themselves, or from the sensors 160, 162, 164 or combination thereof. For example, the sensors 160, 162, 164 can provide data associated with tracking failure modes (e.g., excessive current or voltage, bearing failure, etc.) of the various subsystems 160, 162, 164 to be stored at the controller 125. Such events can be recorded and logged by the controller 125 for each day of operation.

The system 100 can also be in communication with an environmental control system 170 associated with operation of the device 105. The environmental control system 170 can include at least one of a heating and cooling system 175 configured to regulate an operating temperature range of the environment or space 178 located with the device 105.

According to one embodiment, the system 100 can also be in communication with a radiology information server (RIS) 180 operable to communicate diagnostic image information from a CT image acquisition device 105. The system can also be in communication with an Electronic Health Record (EHR) server 185 operable to replicate and manage patient information before a healthcare clinic visit (e.g., lab results, visit notes, diagnostic test results, insurance information, demographics, health histories, medication information, scheduling, patient registration, insurance status, prescriptions, orders for lab tests or diagnostic image acquisition, manage billing, claims submittal and coding, and electronically communicate with their consulting providers, payers, labs and pharmacies).

Having provided the description of an embodiment of the system 100 construction above, the following is a description of a method 200 of operation of the system 100 to regulate a power consumption of the device 105 in accordance with the subject matter described herein. It should also be understood that the sequence of the acts or steps of the method 200 as discussed in the foregoing description can vary. Also, it should be understood that the method 200 may not require each act or step in the foregoing description, or may include additional acts or steps not disclosed herein. It should also be understood that one or more of the steps of the method 200 can be represented by one or more modules of computer-readable program instructions stored in the memory 130 or database 140 of the controller for execution by the processor 135.

Assume that the device 105 and subsystems 110, 115, 120 therein can be in communication (wired or wireless) to receive power and control signals from the controller 125. The controller 125 can provide signals or digital software control via the system modulator 165 to directly or indirectly to apply controlled pulses of electrical power to cause a change in the operating state of the subsystems 110, 115, 120 or to the device 105. Moreover, the controller 125 can monitor a range of operating conditions or parameters of the subsystems 110, 115, 120 or the device 105 as described in more detail below. The signals provided by the controller 125 can include instructions retrieved from storage in the database 140. Under the command of the controller 125, the example of the CT image acquisition device 105 can operate in an ON or ACTIVE state such that the subsystems 110, 115, 120 are operating at a duty cycle to readily produce a stream of radiation for image acquisition of a patient, an OFF or POWER DOWN state of the device 105 such that the duty cycle of one or more subsystems 110, 115, 120 is at its lowest, or in an IDLE or STANDBY state such that the duty cycle of one or more subsystems 110, 115, 120 is somewhere in between that of the ON state and the OFF state.

Step 205 includes the system 100 collecting historical and forward looking data associated with a demand of operation of the device 105 for which the system 100 is in communication to adaptively regulate energy consumptions. Step 205.1 can include collecting data from the RIS server 180 and EHR server 185 associated with a scheduled of use of the device 105 over a predefined period (e.g., business day), such as scheduled times and patients for patient CT image acquisition, clinical application of image acquisition, scheduled operator for image acquisition, and variable efficiency associated with scheduled time to complete image acquisition. Step 205.2 can include collecting data associated with historical variance in energy consumption demand on the device 105 which can be associated with a schedule operator or variable with predefined periods (e.g., seasons) of the year. Step 205.3 can include collecting data associated with variable utility rates and rebates associated with the time of energy consumption of the device 105. Step 205.4 can include collecting data associated with variable operating states and respective energy consumption of the environmental management system 170 associated with managing the lighting and temperature of the environment 178 of the device 105. Step 205.5 can include collecting data associated with instructions to modulate or adaptively regulate control of the subsystems 110, 115, 120 or the device 105 overall.

Step 210 can include applying the data collected in step 205 to a predictive algorithm configured to provide a least energy consumptive or least energy cost state of operation (e.g., ON, OFF, STAND-BY) of the device 105 in general real-time to meet the predictive variable demand on the device 105 over a defined future period. The algorithm can include a predicted variability parameter associated with a demand or load on the device 105, the parameter based on a variable historical load over a predetermined time period, a second parameter for a schedule of variable energy consumption rate demand or load over the future time period, and third parameter for a rate of power, duty cycle, or length of time for each type of demand or load application (e.g., clinical application procedure to perform CT image acquisition) with the device 105 per the schedule of demand or load.

An embodiment of the predictive algorithm or model to output the lowest energy consumption or cost at time (t) of the device 105 in view of the predictive demand over the predefined time interval (t) can be according to the following function: POS(t)=f(schedule of demand, future time, energy modulation control of device, variable utilities, variable operator control, variable seasonal demand, type of demand, efficiency of device operation). The above described function can be represented as a weighted empirical formula, a regression analysis to a parametric equation, etc. The algorithm can also in the form of a lookup table having an operating state of the device 105 to meet the predictive energy consumption or lowest cost on the device 105 over the predefined future time, weighted according to the above described variables associated with operation of the device 105.

For the specific example of the CT image acquisition device 105, the predictive operating state to provide the lowest energy consumption or cost to meet the predictive variable scheduled demand or load on the device associated with scheduled CT image acquisition for that day over the future time period for patients per the schedule data received from the RIS 180 and EHR 185 and associated rate of energy consumption or cost associated with each scheduled demand or load over the future time period, weighted to account for historical variability in demand and operator efficiency, as well as variable utility rates and load or consumption rate restrictions, and ability to modulate control of the device 105 and environment management system 170.

Step 215 can include providing a first signal with instructions for demand of one of a series of operating states of the device 105 as output from the algorithm for communication to the device 105. Step 215 can include comparing the output of the algorithm to a current state of operation of the device 105, and generating the first signal for a change in operation state of the device 105 if there is a difference. In such an example, he controller 125 can be configured to receive a feedback signal of a current operation state of the subsystems 110, 115, 120 or device 105, and to automatically change the signal for instruction for a demand of the operating state of the subsystems 110, 115, 120 or device 105 in response to the feedback signal. In another example, the controller 125 can be configured to receive a feedback signal associated with a scheduled maintenance of the device 105, and be configured to automatically change the demand of the operating state of the device 105 in response to the feedback signal. A scenario where these examples are applicable in changing the operating state of the subsystems 110, 115, 120 or device 105 can be in changing the operating state from STAND BY or IDLE operating state to an OFF state, or from an ON state directly to an OFF state in view of a predicted scheduled maintenance of the device 105.

Step 220 can include communicating the first signal to the device 105. The step 220 can include directly communicating the signal to each of the subsystems 110, 115, 120 of the device 105, or to a system modulator 165 operable to translate the first signal from the controller 125 to a series of sub-signals for instruction of change in operating states of the subsystems 110, 115, 120 in accordance to the received first signal from the controller 125.

Step 225 can include modulation of the operating state of the subsystems 110, 115, 120 or the device 105 overall in response to the received first signal from the controller 125. Step 230 can include receiving feedback associated with the change in operating state of the subsystems 110, 115, 120 or device 105. Step 230 can include receiving data from sensors 160, 162, 164 associated with exceeding thresholds of predefined parameters (e.g., temperature, current, voltage, vibration, bearing wear, etc.).

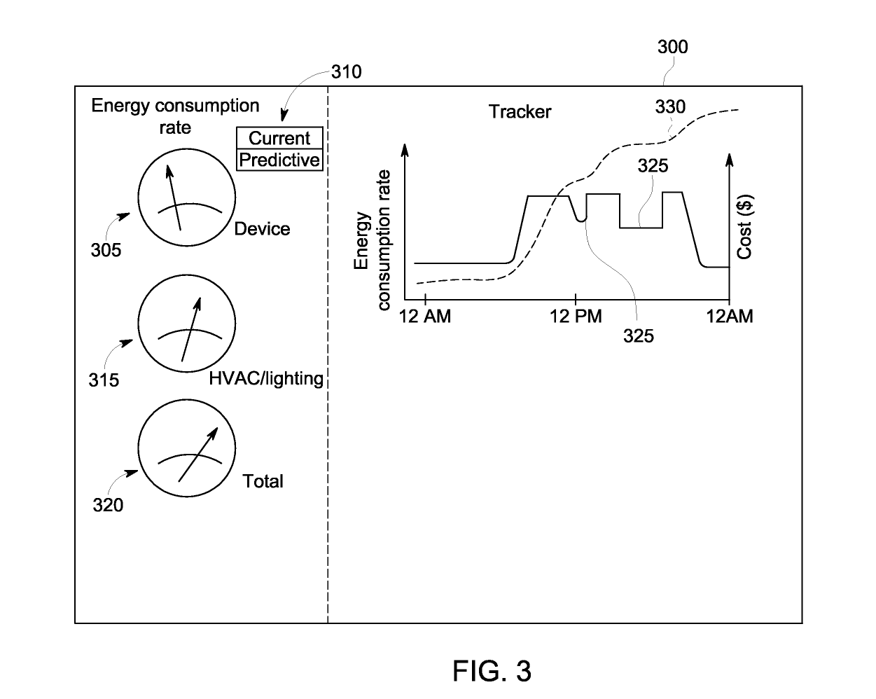

Step 235 can include generating and providing an output 300 (See FIG. 3) to the user via the interface indicative of the change in operation state of the subsystems 110, 115, 120 or device 105 over the predefined time period in view of one or more of the parameters of the algorithm or collected data received by the controller 125 as described above. An example of the output 300 is illustrated in FIG. 3 in accordance to the subject matter described herein. The output 300 can include a visual or graphic illustration 305 of a virtual power meter illustrative of a rate or cumulative energy consumption rate or cost associated with the operating state of the subsystems 110, 115, 120 or the device 105 or combination thereof. The output 300 can further include a selector 310 or drop down menu selection for visual indication of the current consumption rate or cost versus a predictive consumption rate or cost at a future time period. An embodiment of the graphic illustration 305 can be in the form of a meter or gauge with a variably position arrow, or simply be a graphic illustration of a numerical value, bar graph, line graph, or pie charts and the like, or complex data visualization such as multi-context imaging combining physical and numerical coordinates.

Still referring to FIG. 3, in a similar manner associated with illustration 305, the output 300 can further include a similar visual graphic illustration 315 for rate of energy consumption or cost associated with the operating state of the environmental management system 170 and a similar graphic illustration 320 for a total rate of energy consumption or cost associated with the overall or combined operating states of the device 105 and environmental control system 170. The output 300 can further include a graphic illustration 325, 330 of the rate of energy consumption and cost (rate or cumulative), respectively, over a predefined historical or predictive period of time associated with the operating states of the individual device 105 or in combination with the environmental management system 170.

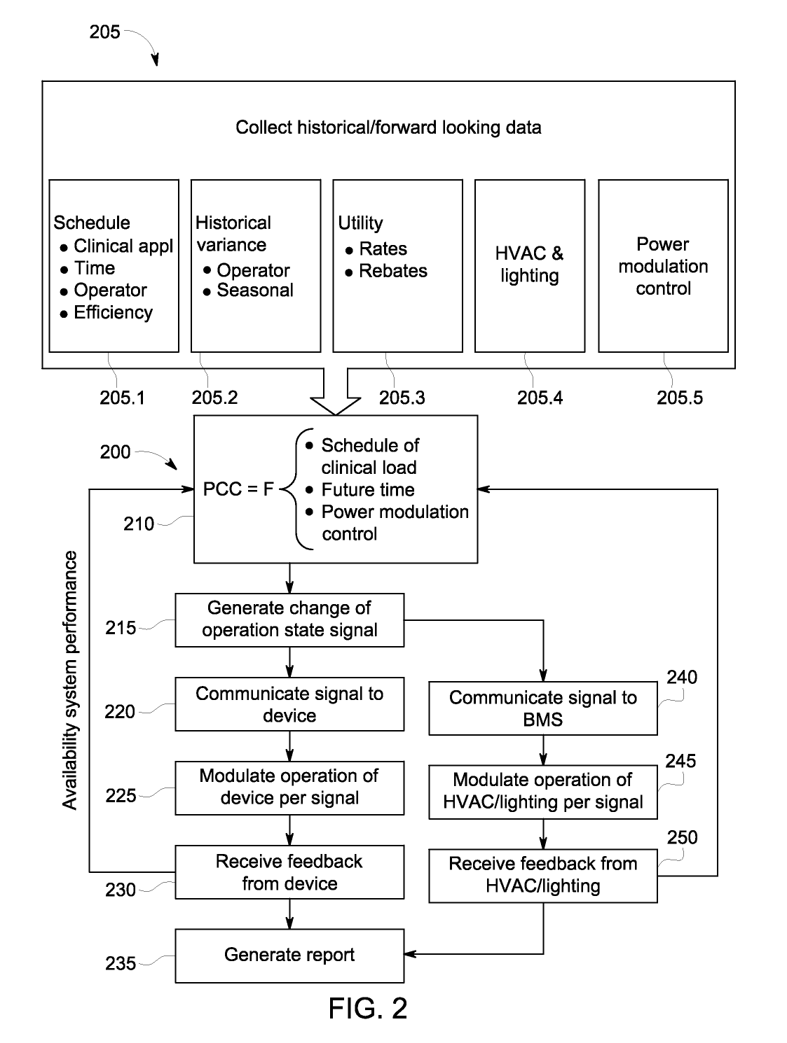

Referring back to FIG. 2, step 240 can include the controller 125 communicating a second signal to instruct a change in operating of the environmental management system 170 in association with the instruction for the change in operating state of the device 105 in accordance to the first signal. An embodiment of the first signal can be generally identical to the second signal (such as a push type communication to all systems subscribing to the network), or distinct therefrom for specific instruction to the subsystems of the environmental management system 170. Step 245 can include modulating or adaptively regulating the operating state of the environmental management system 170 in response to the second signal. Step 250 can include the controller 125 receiving feedback from the environmental management system 170 associated with temperature, humidity, etc. of the space 178 with the device 105. This feedback may be included in the output 300 of the system 100, as described above.

A technical advantage of the system 100 and method 200 can include providing an adaptive energy efficiency capability at the subsystem-level of the device 105 based on past and future workflow dynamics, protocol requirements, etc. The system 100 and method 200 provide ability predict the individual and overall energy demand of the subsystems 110, 115, 120, device 105 and associated environmental management system 170 or combination thereof for a given day. The instruction to the environmental management system 170 can be in response to anticipated heat dissipation associated with the predicted operating states of the subsystems 110, 115, 120 or device 105 and accurately instruct for the operating state of the environmental management system 170 having the lowest rate of energy consumption or cost to meet that predicted change in cooling demand in response to the predicted heat dissipation. The system 100 and method 200 can also provide for providing a visual indicator of a virtual power meter capability, given the correlation of rate of energy consumption or cost associated with each operating state of the subsystems 110, 115, 120 or device 105, providing an economical visual tool to the user.

This written description uses examples to disclose the subject matter, and to enable one skilled in the art to make and use the invention. The patentable scope of the subject matter is defined by the following claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system to regulate an energy consumption of a medical device having a plurality of subsystems, comprising:
a controller connected in communication with the medical device, the controller having a plurality of program instructions for execution by a processor to perform the steps of:
calculating a predicted variability in a customer load on the medical device over a future time period, and generating a signal with an instruction of a demand for one of a plurality of operating states of the medical device based on the predicted customer load, and communicating the signal to the device, wherein the signal changes the operating state of the medical device.

2. The system of claim 1, wherein the calculation of the predicted variability in a customer load is based on an algorithm that includes a first parameter for a historical customer load over a predetermined time period, and a second parameter for a schedule of a customer load over the future time period, and third parameter for a rate of power and length of time for each type of clinical application procedure to perform with the medical device per the schedule of the customer load.

3. The system of claim 2, wherein the algorithm further includes a parameter for a variance in an efficiency of an operator in performing each clinical application procedure with the medical device per the schedule of the customer load.

4. The system of claim 3, wherein the algorithm further includes a parameter for a seasonal change in the customer load.

5. The system of claim 1, further including a system modulator connected in communication between the controller and the medical device, the system modulator configured to dynamically control operation of one or more of the subsystems of the medical device in response to receiving the signal from the controller in a manner to regulate the power consumption of the medical device.

6. The system of claim 1, wherein the controller is configured to receive a second signal that includes a feedback of a current operation state of the medical device, and wherein the controller is configured to automatically change the demand of the operating state of the medical device in response to the second signal.

7. The system of claim 1, wherein the controller is configured to receive a second signal that includes a feedback of a scheduled maintenance of the medical device, and wherein the controller is configured to automatically change the demand of the operating state of the medical device in response to the second signal.

8. The system of claim 1, wherein the algorithm includes a parameter to change the demand on the operating state of the device based on one of a variable utility electrical load restriction and a variable utility electrical consumption rate.

9. The system of claim 1, wherein the controller includes a user interface having a graphic illustration of a substantially current power consumption of the medical device and a predicted power consumption over the future time.

10. A system to regulate a medical device and an environmental control system associated with operation of the medical device, the medical including a plurality of subsystems, comprising:
a controller connected in communication with the medical device, the controller having a plurality of program instructions for execution by a processor to the steps of:
calculating a predicted variability in a customer load on the medical device over a future time period, and generating a signal with an instruction of a demand for one of a plurality of operating states of the medical device based on the predicted variability in the customer load, and communicating the signal to the device, wherein the system communicates a first signal to change the operating state of the medical device, and a second signal to change an operating state of the environmental control system.

11. The system of claim 10, wherein the first signal is different than the second signal.

12. The system of claim 10, wherein the calculation of the predicted variability in the customer load employs an algorithm that includes a first parameter a historical customer load over a predetermined time period, and a second parameter for a schedule of a customer load over the future time period, and third parameter for a rate of power and length of time for each type of clinical application procedure to perform with the medical device per the schedule of the customer load.

13. The system of claim 12, wherein the algorithm further includes a parameter for a variance for an efficiency of an operator in performing each clinical application procedure with the medical device per the schedule of the customer load.

14. The system of claim 10, further including a system modulator connected in communication between the controller and the medical device, the system modulator configured to dynamically control operation of one or more of the subsystems of the medical device in response to receiving the signal from the controller in a manner to regulate the power consumption of the medical device.

15. The system of claim 10, wherein the algorithm includes a parameter to change the demand on the operating state of the device based on one of a variable utility electrical load restriction and a variable utility electrical consumption rate.

16. The system of claim 10, wherein the controller includes a user interface having a graphic illustration of a substantially current power consumption of the medical device and a predicted power consumption of the medical device over the future time.

17. A method to regulate an energy consumption of a medical device having a plurality of subsystems, comprising:
calculating a predicated variability in a customer load over a future time period on the medical device using a processor;
generating a signal with an instruction to demand one of a plurality of operating states of the medical device based on the calculating step; and
communicating the signal over a network to the device, wherein the signal changes the operating state of the medical device.

18. The method of claim 17, wherein step of calculating the predicted variability in the customer load is based on a historical customer load over a predetermined time period, a schedule of a customer load over the future time period, a rate of power and length of time for each type of clinical application procedure to perform with the medical device per the schedule of the customer load, and a variance for an efficiency of an operator in performing each clinical application procedure with the medical device per the schedule of the customer load.

19. The method of claim 17, wherein the step of calculating the predicted customer load further includes a parameter for a seasonal change in the customer load over the future time period.

20. The method of claim 19, further including the step of communicating the signal from the controller to a system modulator connected between the controller and the medical device, and the system modulator dynamically controlling a change in an operating state of one or more of the subsystems of the medical device in response to receiving the signal from the controller.
